(19) United States
(12) Patent Application Publication
(10) Pub. No.: US 2026/0321861 A1
(43) Pub. Date: Oct. 15, 2026

(54) BATTERY CELL STACK

(71) Applicant: JAGUAR LAND ROVER LIMITED, Whitley, Coventry, Warwickshire (GB)

(72) Inventors: Paul HANEY, Whitley, Coventry, Warwickshire (GB); Ahmed ABAZA, Whitley, Coventry, Warwickshire (GB)

(21) Appl. No.: 19/482,158

(22) PCT Filed: May 23, 2024
(86) PCT No.: PCT/EP2024/064260

§ 371 Date: Nov. 6, 2025

(30) Foreign Application Priority Data
May 24, 2023 (GB) 2307798.5

(51) Int. Cl. H01M 50/291; B60L 50/64; H01M 50/204; H01M 50/244

(52) U.S. Cl. CPC H01M 50/291; B60L 50/64; H01M 50/204; H01M 50/244

(57) ABSTRACT

A battery cell stack for a battery includes a first battery cell; a second battery cell arranged adjacently to the first battery cell; and a spacer positioned between the first and second battery cells. The spacer includes a compressible pad, and a support element supporting the compressible pad. The spacer is compressible between the first and second battery cells.

### TECHNICAL FIELD

The present disclosure relates to a battery cell stack. Aspects of the invention relate to a battery cell stack for a battery, a battery comprising a battery cell stack, a vehicle comprising a battery and a method of assembling a battery cell stack for a battery.

### BACKGROUND

It is known to provide battery cell stacks including a number of battery cells arranged in parallel. Battery cells in such stacks abut each other and generally need to be held in a housing or casing, which adds to the space envelope occupied by batteries as well as their weight. During thermal events, heat can spread between battery cells in this configuration. Similarly, because the battery cells are in physical contact there is a potential for short circuits to occur.

It is an aim of the present invention to address one or more of the disadvantages associated with the prior art.

### SUMMARY OF THE INVENTION

Aspects and embodiments of the invention provide a battery cell stack for a battery, a battery comprising a battery cell stack, a vehicle comprising a battery and a method of assembling a battery cell stack for a battery.

According to an aspect of the invention there is provided a battery cell stack for a battery. The battery cell stack may comprise a first battery cell, a second battery cell, for example a second battery cell arranged adjacently to the first battery cell, and a spacer, for example a compressible spacer.

Advantageously, the spacer provides internal structural integrity to the battery cell stack, removing the need for an external casing or housing, which would add size and weight to the battery cell stack. The compressible spacer advantageously accommodates tolerances in components of the battery cell stack, for example variations in the size of battery cells arising during manufacture.

In an embodiment, the spacer comprises a compressible pad and a support element, for example a support element supporting the compressible pad. The spacer may be compressible between the first battery cell and the second battery cell.

Advantageously, the compressible pad accommodates changes in the size of battery cells arising through expansion of battery cells in use.

According to another aspect of the invention there is provided a battery cell stack for a battery, the battery cell stack comprising: a first battery cell; a second battery cell arranged adjacently to the first battery cell; and a spacer positioned between the first and second battery cells, the spacer comprising a compressible pad, and a support element supporting the compressible pad, wherein the spacer is compressible between the first and second battery cells.

Advantageously, the spacer provides internal structural integrity to the battery cell stack, removing the need for an external casing or housing, which would add size and weight to the battery cell stack. The compressible spacer advantageously accommodates tolerances in components of the battery cell stack, for example variations in the size of battery cells arising during manufacture. The compressible pad also accommodates changes in the size of battery cells arising through expansion of battery cells in use.

In an embodiment, the first battery cell and/or the second battery cell comprises a first face and a second opposing face. The spacer may be compressible between one of the first face and the second face of the first battery cell and one of the first face and the second face of the second battery cell. The spacer may be, for example, compressible between the first face of the first battery cell and the second face of the second battery cell. Alternatively, the spacer may be compressible between the second face of the first battery cell and the first face of the second battery cell.

The first and second faces of the first and/or second battery cells beneficially provide an interface for connection or attachment to the spacer.

In an embodiment, the spacer comprises a first surface and a second opposing surface. The first surface of the spacer may abut the one of the first face and the second face of the first battery cell. The second surface of the spacer may abut the one of the first face and the second face of the second battery cell. The first surface of the spacer may, for example, abut the first face of the first battery cell and the second surface of the spacer may abut the second face of the second battery cell. Alternatively, the first surface of the spacer may abut the second face of the first battery cell and the second surface of the spacer may abut the first face of the second battery cell.

The first and second surfaces of the spacer beneficially provide an interface for connection or attachment to the battery cells.

In an embodiment, the first and/or second faces of each of the first and/or second battery cells are substantially planar.

The planar first and/or second faces of the first and/or second battery cells advantageously improve the contact between the interfacing portions of the battery cells and the spacer.

In an embodiment, the first and second battery cells are arranged such that the first and second faces of each of the first and second battery cells are parallel.

The parallel arrangement of the first and second battery cells beneficially supports efficient packing of the battery cell stack.

In an embodiment, the battery cell stack comprises an adhesive. The adhesive may be configured to attach the spacer to the one of the first face and the second face of the first battery cell. The adhesive may be a first adhesive. The first adhesive may be a first adhesive layer, for example a first adhesive tape. The battery cell stack may comprise a second adhesive. The second adhesive may be configured to attach the spacer to the one of the first face and the second face of the second battery cell. The second adhesive may be a second adhesive layer, for example a second adhesive tape. The first and/or the second adhesive tape may be a double-sided adhesive tape.

Advantageously, the adhesive, for example the adhesive layer or tape, improves the internal structural rigidity of the battery cell stack, enabling the provision of a self-supporting battery cell stack and removing the need for external structural components, e.g. a casing or housing, which would increase the size and/or weight of the battery cell stack.

In an embodiment, the support element has a first compressibility and the compressible pad has a second compressibility. The first compressibility may be lower than the second compressibility. In an embodiment, the first compressibility (i.e. the compressibility of the support element) may be 10 to 100 times lower than the second compressibility (i.e. the compressibility of the compressible pad). The first compressibility (i.e. the compressibility of the support element) may be lower than the second compressibility (i.e. the compressibility of the compressible pad) at standard operating temperatures of a battery cell stack or a battery pack with which the spacer is used. The standard operating temperatures of the battery cell stack or the battery pack may be from approximately −50 °C to approximately 100 °C, for example from approximately −40 °C to approximately 50 °C.

Advantageously, the additional volume required by the expanded battery cells is accommodated by the compressible pad in preference to the support element since the compressible pad has a higher compressibility than the support element.

In an embodiment, the elastic modulus of the support element may be approximately 10 to approximately 150 MPa.

Advantageously, the elastic modulus of the support element is high enough to provide mechanical integrity and resist delamination under vibration and low enough to enable compression and prevent damage to battery cells.

In an embodiment, the compressible pad is attached to the support element. The support element may be, for example, fixedly attached to and supporting the compressible pad.

The attachment of the compressible pad to the support element advantageously ensures that the support element supports the compressible pad.

In an embodiment, the support element is a frame. The frame may, for example, at least partly surround a perimeter, e.g. an outer perimeter, of the compressible pad. The frame may extend around an entire perimeter, e.g. an entire outer perimeter, of the compressible pad.

In an embodiment, the support element may define a central aperture within which the compressible pad is located.

The frame advantageously supports the compressible pad, in particular the outer periphery of the compressible pad.

In an embodiment, the compressible pad comprises an anti-thermal propagation material. Additionally or alternatively, the compressible pad may comprise a dielectric material. The compressible pad may comprise an electrically insulating material.

In this way, the spacer beneficially enables adjacent battery cells to be thermally and/or electrically insulated or separated.

In an embodiment, the support element comprises a thermoplastic elastomer.

In an embodiment, the spacer is at least 0.8 mm thick. The spacer may be at least 1 mm thick, for example at least 3 mm thick.

Either or each of the compressible pad and the support element may be at least 0.8 mm thick. Either or each of the compressible pad and the support element may be at least 1 mm thick, for example at least 3 mm thick.

Advantageously, the spacer provides structural integrity for a battery cell stack, can accommodate variances in the size of battery cells in a battery cell stack during manufacture and as a result of expansion from use and provides a thermal and electrical barrier between battery cells, whilst not occupying a compact volume or space envelope.

In an embodiment, the spacer has a spacer height, a spacer width and a spacer thickness. The support element may have a support element height, a support element width and a support element thickness. The compressible pad may have a compressible pad height, a compressible pad width and a compressible pad thickness. The spacer thickness may be at least 0.8 mm. The spacer thickness may be at least 1 mm, for example at least 3 mm. The compressible pad thickness and/or the support element thickness may be at least 0.8 mm. The compressible pad thickness and/or the support element thickness may be at least 1 mm, for example at least 3 mm thick.

The or each battery cell may have a battery cell height, a battery cell width and a battery cell thickness.

The spacer height may correspond to, or be the same as, the battery cell height. Additionally, or alternatively, the spacer width may correspond to, or be the same as, the battery cell width.

In an embodiment, the spacer height is approximately 5% greater than the battery cell height. Additionally, or alternatively, the spacer width may be approximately 5% greater than the battery cell width.

In an embodiment, the spacer thickness is less than the battery cell thickness.

In an embodiment, the spacer has a thickness. When compressed between the first and second battery cells, the thickness of the spacer may be reduced by approximately 1 to 5%. The thickness of the spacer may be reduced by approximately 0.05 mm.

Advantageously, the compressible spacer accommodates tolerances in components of the battery cell stack, for example variations in the size of battery cells arising during manufacture.

In an embodiment, the battery cell stack comprises a support bracket. The support bracket may be attached to the first battery cell and/or the second battery cell. The support bracket may be an angle bracket, for example an L-bracket.

The support bracket enhances the structural integrity of the battery cell stack without the need for a casing or housing which would increase the size and/or weight of the battery cell stack.

In an embodiment, the battery cell stack comprises an end plate. The end plate may be attached to an outermost battery cell or an outermost spacer of the battery cell stack. The battery cell stack may include a first end and a second opposing end. The end plate may be a first end plate. The first end plate may be attached at the first end of the battery cell stack, for example to an outermost battery cell or an outermost spacer at the first end of the battery cell stack. The battery cell stack may comprise a second end plate. The second end plate may be attached at the second end of the battery cell stack, for example to an outermost battery cell or an outermost spacer at the second end of the battery cell stack. The or each end plate may be attached to the or a support bracket of the battery cell stack using any suitable attachment means, for example a rivet, a bolt, a weld or similar.

The or each end plate advantageously enhances the structural integrity of the battery cell stack without the need for a casing or housing which would increase the size and/or weight of the battery cell stack.

In an embodiment, the battery cell stack comprises a cooling plate. The cooling plate may be attached to the or an end plate and/or the or a support bracket of the battery cell stack.

The cooling plate beneficially enables the temperature of the components of the battery cell stack to be reduced in order to prevent thermal events.

In an embodiment, the battery cell stack comprises a plurality of battery cells, for example a plurality of first battery cells and/or a plurality of second battery cells. The battery cell stack may comprise a plurality of spacers, wherein each cell of the plurality of battery cells is separated by a spacer of the plurality of spacers.

According to an aspect of the invention there is provided a battery comprising a battery cell stack according to the above aspects of the invention.

According to a further aspect of the invention there is provided a vehicle comprising a battery according to the previous aspect of the invention.

According to a yet further aspect of the invention there is provided a method of assembling a battery cell stack for a battery, the method comprising providing a first battery cell; providing a second battery cell, adjacent to the first battery cell; providing a spacer comprising a compressible pad and a support element supporting the compressible pad; and positioning the spacer between the first battery cell and the second battery cell.

Advantageously, the spacer provides internal structural integrity to the battery cell stack, removing the need for an external casing or housing, which would add size and weight to the battery cell stack.

In an embodiment, the method comprises providing a plurality of the first and/or second battery cells; providing a plurality of the spacers; and positioning one spacer of the plurality of the spacers between each battery cell of the plurality of first and/or second battery cells.

In an embodiment, the method comprises providing an adhesive, for example an adhesive layer or adhesive tape and securing each of the battery cells to the spacer or spacers using the adhesive.

Advantageously, the adhesive, for example the adhesive layer or tape, improves the internal structural rigidity of the battery cell stack, enabling the provision of a self-supporting battery cell stack and removing the need for external structural components, e.g. a casing or housing, which would increase the size and/or weight of the battery cell stack.

In an embodiment, the method comprises urging the or each first battery cell and the or each second battery cell together, such that the spacer or spacers is at least partially compressed between the or each first battery cell and the or each second battery cell. The method may comprise applying a compressive force to urge the first battery cell in a first direction toward the spacer. Additionally or alternatively, the method may comprise applying a compressive force to urge the second battery cell in a second opposing direction toward the spacer. The application of the compressive force in the first direction and/or the application of the compressive force in the second direction may result in the thickness of the support element being reduced by approximately 1 to 5%. The thickness of the support element may be reduced by approximately 0.05 mm.

The compressible spacer advantageously accommodates tolerances in components of the battery cell stack, for example variations in the size of battery cells arising during manufacture.

In an embodiment, the method comprises providing a jig, and urging the or each first battery cell and the or each second battery cell together using the jig.

In an embodiment, the method comprises providing a support bracket; and adhering the support bracket to the or each first battery cell and/or the or each second battery cell.

The support bracket enhances the structural integrity of the battery cell stack without the need for a casing or housing which would increase the size and/or weight of the battery cell stack.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1A shows a front view of a spacer in accordance with an embodiment of the invention;

FIG. 1B shows a side view of a spacer in accordance with an embodiment of the invention;

FIG. 1C shows an alternative front view of a spacer in accordance with an embodiment of the invention;

FIG. 1D shows a front view of a battery cell;

FIG. 2 shows a battery cell stack in accordance with an embodiment of the present invention;

FIG. 3 shows a method of making a battery cell stack according to an embodiment of the invention;

FIG. 4 shows a plurality of battery cell stacks forming a battery in accordance with an embodiment of the present invention; and

FIG. 5 shows a vehicle in accordance with an embodiment of the invention.

### DETAILED DESCRIPTION

In the following detailed description, reference is made to the accompanying figures that form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical, and electrical changes may be made without departing from the scope of the present invention. The sequence of operations is not limited to that set forth herein and may be changed as will be apparent to those skilled in the art, with the exception of operations necessarily occurring in a certain order.

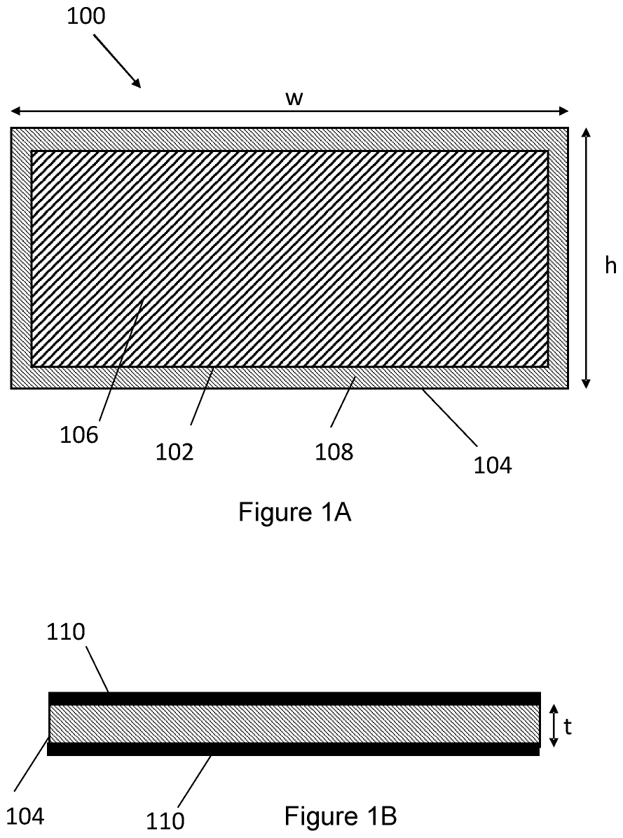

With reference to FIG. 1A, there is illustrated a spacer 100 for a battery cell stack 200. FIG. 1A shows a spacer 100 which is generally rectangular in plan view. The spacer 100 includes a compressible pad 102 and a support element 104. The compressible pad 102 is generally rectangular in plan view and includes a first face 106 and an opposing second face (not shown), each of which abuts a face of a corresponding battery cell (not shown) within the battery cell stack 200. As shown in FIG. 1A, the support element 104 is a generally rectangular frame which extends around an outer periphery of the compressible pad 102. The support element 104 comprises a first support face 108 and an opposing second support face (not shown), each of which also abuts a corresponding battery cell (not shown) within the battery cell stack 200.

In some examples, the first face 106 and/or the second face of the compressible pad 102 and/or the first support face 108 and/or the second support face of the support element 104 will not directly abut a battery cell. In some examples, a layer of adhesive, e.g. an adhesive tape, is disposed between the battery cell and the relevant face(s) of the spacer 100. The spacer 100 is substantially symmetrical such that the first face 106 of the compressible pad 102 and the first support face 108 of the support element 104 form a first face of the spacer 100 and there is also an opposing second face on the other side of the spacer 100, including the second face of the compressible pad 102 and the second support face of the support element 104, which allows the spacer 100 to be sandwiched between two battery cells.

With particular reference to FIG. 1A, the spacer 100 has a width dimension, denoted by the reference “w” and a height direction denoted by the reference “h”. Each of the compressible pad 102 and the support element 104 extend in the same height and width directions. The support element 104 comprises a central aperture, in which the compressible pad 102 is located. The compressible pad 102 located within the central aperture is designed to deform under load. Battery cells expand during their lifetime. In the absence of a volume to expand into, the lifespan of battery cells within a battery cell stack and/or a battery may be reduced. Advantageously, providing a spacer 100 having a support element 104 with a central aperture within which a compressible pad 106 is located provides such a volume into which the battery cells can expand.

The compressible pad 102 serves several functions within the battery cell stack. In various embodiments of the invention, the compressible pad 102 will provide one or more of these benefits. The compressible pad 102 may, for example, provide a thermal barrier between adjacent battery cells in the battery cell stack. The compressible pad 102 may, for example, include an anti-thermal propagation (ATP) material. This barrier function may be beneficial in preventing or alleviating thermal events in batteries. For example, if one cell begins to heat up outside of ideal conditions, then the compressible pad provides a barrier to prevent the heat spreading to neighbouring battery cells within in the battery cell stack. A further benefit may be the formation of an electrical barrier between the battery cells in the battery cell stack. The compressible pad 102 may be formed of a material which has a high electrical resistivity. The compressible pad 102 may, for example, include a material having dielectric properties or being a dielectric material. As such, the compressible pad 102 provides protection from potential short circuits between the battery cells or other components in the battery and/or the battery cell stack.

The support element 104 and the compressible pad 102 have different material properties, including different compressibilities and Young's moduli. The support element 104 is made from and/or comprises a material which deforms less for a given applied load or pressure, i.e. is less compressible, than the compressible pad 102. Put another way, the compressible pad 102 may have a lower Young's modulus, i.e. is less stiff or can be more easily compressed or deformed under applied stress, than the support element 104.

The compressible pad 102 may have a Young's modulus 10-100 times lower than the support element 104. Over the lifetime of a battery, the battery cells will expand; that is, their volume will increase. Providing the compressible pad 102 within the support element 104 advantageously provides a volume for the battery cells to expand into, because the compressible pad 102 will deform preferentially relative to the support element 104, due to the higher Young's modulus of the support element 104.

With reference to FIG. 1B, there is illustrated a side view of the spacer 100 of FIG. 1A with an adhesive 110 on opposing sides of the spacer. The thickness dimension of the spacer (the spacer thickness) is denoted by reference “t”. In examples of the invention, the spacer may have a thickness t of at least 1 mm. In other examples, the spacer may have a thickness of at least 0.8 mm. The adhesive is provided on the support element 104 or the compressible pad (not shown) or both. In some examples, the adhesive 110 is used to attach the compressible pad 102 to the support element 104. In some embodiments, the adhesive(s) may be used to attach, adhere or fix the spacer 100 to a battery cell on either side of the spacer 100 or to battery cells on both sides of the spacer 100. It will be understood by the skilled person that there are a plurality of appropriate adhesives which can be used in this context. A non-exhaustive list of appropriate adhesives includes adhesive tape, e.g. double-sided adhesive tape, any wet applied adhesive, structural adhesive or curable adhesive.

Referring now to FIG. 1C, there is illustrated an example of a front view of the spacer 100 to which four pieces or lengths of adhesive tape 110 have been applied. Each piece of the adhesive tape 110 overlaps a portion of the compressible pad 102 and a portion of the support element 104 such that the adhesive tape fixes, adheres or attaches the compressible pad 102 within the central aperture of the support element 104. Each piece of the adhesive tape 110 may be double-sided such that a first face or side of each piece of the adhesive tape 110 is adhered to a portion of the compressible pad 102 and a portion of the support element 104 and an opposing second face or side of each piece of the adhesive tape 110 is adhered to a battery cell such that the spacer 100 may be fixed, adhered or attached to the battery cell.

Referring now to FIG. 1D, there is illustrated an example of a front view of a battery cell 202. The battery cell includes a first face 203 and an opposing second face (not shown). In some example battery cell stacks, the first face 203 and the second face (not shown) will directly abut a spacer 100. In other examples, an adhesive, an adhesive layer or an adhesive tape may attach the spacer 100 to the first face 203 and the second face (not shown). In various examples, the support element 104 or the compressible pad 102 or each of the support element 104 and the compressible pad 102 may be in direct contact with the first face 203 of the battery cell 202. Alternatively, an adhesive, an adhesive layer or an adhesive tape may attach the or each of the support element 104 or the compressible pad 102 or each of the support element 104 and the compressible pad 102 to the battery cell 202.

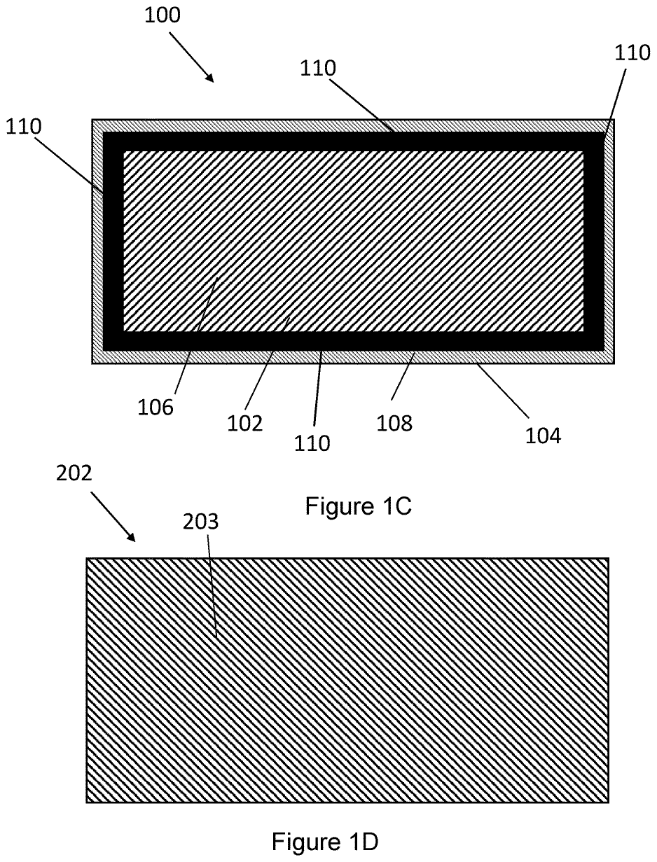

With reference to FIG. 2, there is illustrated a battery cell stack 200. A battery cell stack 200, also known as a battery stack, is a series of individual battery cells 202 that are connected together by a busbar (not shown), or similar, in an electrically-parallel configuration. The present disclosure relates generally to prismatic battery cells however the battery cells may be pouch cells or cylindrical cells. Multiple battery cells 202 are stacked together, generally by a busbar or other connection means. This allows the voltage of the individual battery cells to add up, resulting in a higher overall voltage for the battery cell stack. Battery cell stacks are commonly used in a wide range of applications, including electric vehicles, renewable energy systems, and portable electronic devices, among others.

As shown in FIG. 2, the spacers 100 of the present invention are sandwiched between battery cells 202, such that a battery cell stack 200 comprises a plurality of battery cells 202 and spacers 100. In some examples, end plates 204A, 204B connect to respective outermost battery cells 202A, 202B. In alternative examples, an outermost spacer may be located between the end plates 204A, 204B and the outermost battery cells 202A, 202B. During manufacture of the battery cell stack 200, the battery cells 202 and/or the spacers 100 may be compressed relative to their free shape. To ensure that the components of battery cell stack 200 remain in their compressed state a support bracket 208 may be attached to the end plates 204A, 204B using an attachment means 206A, 206B, such as a rivet, bolt, weld or similar. In some examples, two brackets 208 may be used, each including attachment means 206A, 206B.

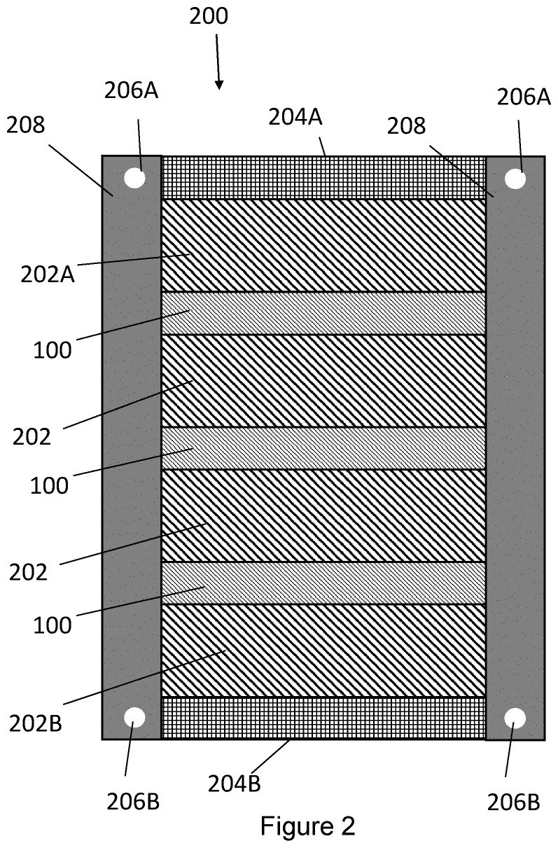

FIG. 3 shows a flowchart 300 depicting a method of assembling a battery cell stack for a battery, the method includes: providing a first battery cell at 302; providing a second battery cell, adjacent to the first battery cell at 304; positioning a spacer between the first battery cell and the second battery cell at 306; and urging the first battery cell and the second battery cell together such that the compressible spacer is at least partially compressed at 308.

The method 300 of FIG. 3 provides various optional method steps including providing a plurality of battery cells and a plurality of spacers and wherein a spacer of the plurality of spacers is positioned between each of the battery cells of the plurality of battery cells at 310. According to a further optional method step, the method further includes providing an adhesive and securing said battery cells to said spacer or spacers using said adhesive at 312. According to a further optional method step, the method further includes providing a jig and urging said battery cells together using the jig at 314. According to a further optional method step, the method further includes adhering or otherwise attaching or fixing a support bracket to the or each spacer at 316.

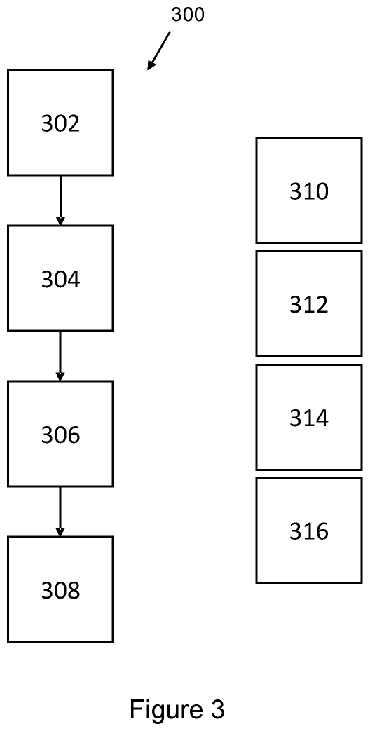

FIG. 4 shows a segment of a battery 400 comprising a plurality of battery cell stacks 200. The battery cell stacks may be attached in series or in parallel. Additionally, the battery cell stacks may be in contact with a cooling plate, with either the spacer or battery cells in contact with the cooling plate (not shown). The battery cell stacks may be adjacent or stacked on top of each other or both stacked and adjacent to each other. There may be an air gap or housing between the battery cell stacks 200.

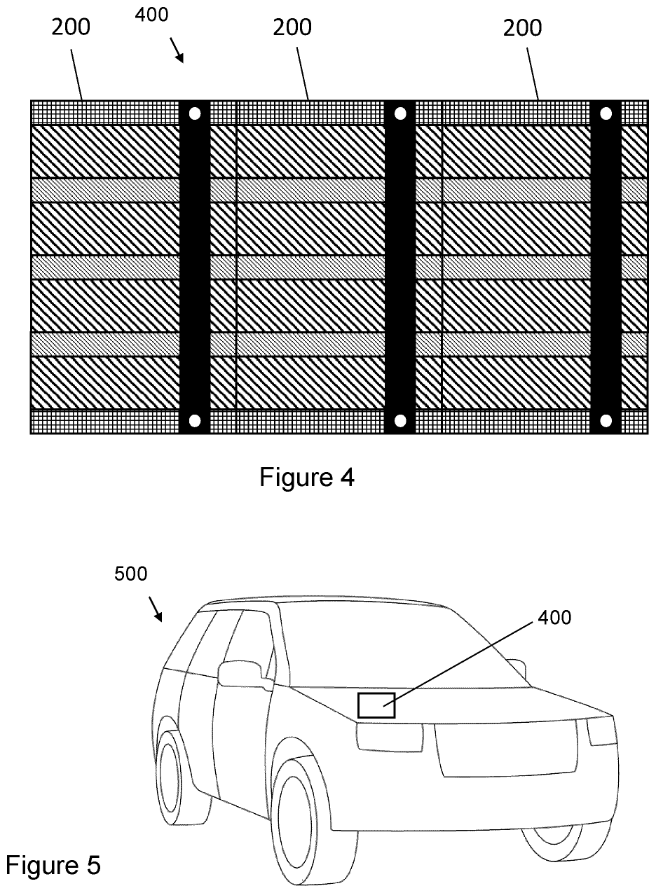

A vehicle 500 in accordance with an embodiment of the present invention is described herein with reference to the accompanying FIG. 5. The vehicle includes a battery 400 in accordance with examples of the present invention. The vehicle 500 in the present embodiment is an automobile, such as a wheeled vehicle, but it will be understood that the battery spacer 100, battery cell stack 200 or battery 400 described above may be used in other types of vehicle, such as aircraft, watercraft etc. as well as in homes.

It will be appreciated that various changes and modifications can be made to the present invention without departing from the scope of the present application.

In the example described above, the compressible pad 102 is generally rectangular in plan view. It will be understood that, in other examples of the invention, the compressible pad may be any shape in plan view.

In the example described above, the support element 104 is a generally rectangular frame which extends around an outer periphery of the compressible pad 102. In other examples of the invention, the support element may support part of the compressible pad 102. The support element may have an upper edge and/or a lower edge and/or a first side edge and/or a second side edge of the compressible pad 102. The support element may be, for example, L-shaped or U-shaped in section. In other examples of the invention, a portion of the support element may extend across a central portion of the compressible pad 102. The support element may be, for example, H-shaped in section in this case.

In the example described above, an adhesive, for example an adhesive tape, is provided between the battery cell and the relevant face(s) of the spacer 100. It will be understood that, in alternative examples of the invention, an adhesive glue may be provided between the battery cells and the relevant face(s) of the spacer 100.

The adhesive, for example the adhesive tape or adhesive glue is provided to adhere the respective spacer(s) 100 and battery cells. It will be understood that, in alternative examples of the invention, other suitable methods of fixing the respective spacer(s) 100 and battery cells may be provided, for example heat sealing.

1. A battery cell stack for a battery, the battery cell stack comprising:
a first battery cell;
a second battery cell arranged adjacent to the first battery cell; and
a spacer positioned between the first and second battery cells, the spacer comprising a compressible pad, and a support element supporting the compressible pad,
wherein the spacer is compressible between the first and second battery cells.

2. The battery cell stack of claim 1 wherein each of the first battery cell and the second battery cell comprise a first face and a second opposing face, and
wherein the spacer is compressible between one of the first face and the second face of the first battery cell and one of the first face and the second face of the second battery cell.

3. The battery cell stack of claim 2 wherein the spacer comprises a first surface and a second opposing surface, and
wherein the first surface of the spacer abuts the one of the first face and the second face of the first battery cell and the second surface of the spacer abuts the one of the first face and the second face of the second battery cell.

4. The battery cell stack of claim 2 wherein the first and second battery cells are arranged such that the first and second faces of each of the first and second battery cells are parallel.

5. The battery cell stack of claim 2 further comprising an adhesive, wherein the adhesive is configured to attach the spacer to the one of the first face and the second face of the first battery cell.

6. The battery cell stack of claim 5, wherein the adhesive is a first adhesive, the battery cell stack comprising a second adhesive, wherein the second adhesive is configured to attach the spacer to the one of the first face and the second face of the second battery cell.

7. The battery cell stack of claim 1 wherein the spacer has a thickness and, when compressed between the first and second battery cells, the thickness of the spacer is reduced by approximately 1 to 5%.

8. The battery cell stack of claim 1 further comprising a support bracket,
wherein the support bracket is attached to the first battery cell and the second battery cell.

9. The battery cell stack of claim 1 further comprising a plurality of battery cells and a plurality of spacers,
wherein each cell of the plurality of battery cells is separated by a spacer of the plurality of spacers.

10. A vehicle comprising a battery comprising a battery cell stack according to claim 1.

11. A method of assembling a battery cell stack for a battery, the method comprising:
providing a first battery cell;
providing a second battery cell, adjacent to the first battery cell;
providing a spacer comprising a compressible pad and a support element supporting the compressible pad; and
positioning the spacer between the first battery cell and the second battery cell.

12. The method of claim 11 comprising:
providing a plurality of the first and/or second battery cells;
providing a plurality of the spacers; and
positioning one spacer of the plurality of the spacers between each battery cell of the plurality of first and/or second battery cells.

13. The method of claim 11 further comprising:
providing an adhesive, and
securing each of the battery cells to the spacer or spacers using the adhesive.

14. The method of claim 12 further comprising:
providing a jig,
using said jig to urge the or each first battery cell and the or each second battery cell together, such that the spacer or spacers is at least partially compressed between the or each first battery cell and the or each second battery cell.

15. The method of claim 11 further comprising:
providing a support bracket; and
adhering the support bracket to the or each first battery cell and the or each second battery cell.
